(19) United States
(12) Patent Application Publication
(10) Pub. No.: US 2015/0120828 A1
(43) Pub. Date: Apr. 30, 2015

(54) RECALLING ACTIVITIES DURING COMMUNICATION SESSIONS

(71) Applicant: International Business Machines Corporation, Armonk, NY (US)

(72) Inventors: Corville O. Allen, Morrisville, NC (US); Joel Duquene, Raleigh, NC (US); Henri F. Meli, Cary, NC (US)

(73) Assignee: International Business Machines Corporation, Armonk, NY (US)

(21) Appl. No.: 14/065,749

(22) Filed: Oct. 29, 2013

(51) Int. Cl. H04L 12/58

(52) U.S. Cl. CPC H04L 51/046; H04L 51/04
USPC 709/204

(57) ABSTRACT

A computer-implemented method, computer program product, and computing system is provided for quality of experience for media transmissions. In an implementation, a method may include identifying a communication session including a plurality of participants. The method may also include identifying an application activity by a first participant of the communication session. The application activity may be generally contemporaneous with the communication session. The method may also include associating a relevance level with the application activity and the communication session. The method may also include identifying a location associated with the application activity. The method may further include storing an association between the communication session, the application activity, the relevance, and the location.

### TECHNICAL FIELD

The present disclosure generally relates to systems and method for collaborative communications, and more particularly relates to logging and recalling activities during communication sessions.

### BACKGROUND

The Internet currently allows for the free exchange of ideas and information in a manner that was unimaginable only a couple of decades ago. One such use for the Internet is as a communication medium, whether it is via one-on-one exchanges or multi-party exchanges. For example, two individuals may exchange private emails with each other, and engage in instant messaging chat sessions. Similarly, many social networking applications and websites may allow individuals to communicate with one another, for example, through synchronous posting of entries that are published for multiple people to read. Social networking applications and websites may also allow more synchronous, or real-time, communications between users, for example, in the form of instant messaging-like chats, video conferencing, voice conferencing, and the like. The Internet may further be used to distribute content to users. For example, video content, text and/or graphical material, and the like, may be simultaneously multicast to a plurality of user in the form of an online meeting, or other collaborative forum.

### SUMMARY OF DISCLOSURE

According to an implementation, a computer-implemented method may include identifying a communication session including a plurality of participants. The method may also include identifying an application activity by a first participant of the communication session. The application activity may be generally contemporaneous with the communication session. The method may also include associating a relevance level with the application activity and the communication session. The method may also include identifying a location associated with the application activity. The method may further include storing an association between the communication session, the application activity, the relevance, and the location.

One or more of the following features may be included. The communication session may include one or more of instant messaging, email, social networking communication, voice communication, video communication, and an electronic meeting. The location associated with the application activity may include a location of the first participant during the application activity. The location associated with the application activity may include a location of content associated with the application activity.

Storing the association between the communication session, the application activity, the relevance, and the location may include storing a sequenced description of the application activity. The method may include generating a sequential recall of the application activity for the communication session. The method may also include sorting the sequential recall based upon, at least in part, the relevance level.

According to another implementation, a computer program product may include a computer readable storage medium having a plurality of instructions stored on it. When executed by a processor, the instructions may cause the processor to perform operations including identifying a communication session including a plurality of participants. Instructions may also be included for identifying an application activity by a first participant of the communication session. The application activity may be generally contemporaneous with the communication session. Instructions may also be included for associating a relevance level with the application activity and the communication session. Instructions may also be included for identifying a location associated with the application activity. Instructions may further be included for storing an association between the communication session, the application activity, the relevance, and the location.

One or more of the following features may be included. The communication session may include one or more of instant messaging, email, social networking communication, voice communication, video communication, and an electronic meeting. The location associated with the application activity may include a location of the first participant during the application activity. The location associated with the application activity may include a location of content associated with the application activity.

The instructions for storing the association between the communication session, the application activity, the relevance, and the location may include instructions for a storing a sequenced description of the application activity. Instructions may be included for generating a sequential recall of the application activity for the communication session. Instructions may also be included for sorting the sequential recall based upon, at least in part, the relevance level.

According to another implementation, a computing system may include a processor and a memory architecture coupled with the processor. The processor may be configured for identifying a communication session including a plurality of participants. The processor may also be configured for identifying an application activity by a first participant of the communication session. The application activity may be generally contemporaneous with the communication session. The processor may also be configured for associating a relevance level with the application activity and the communication session. The processor may also be configured for identifying a location associated with the application activity. The processor may further be configured for storing an association between the communication session, the application activity, the relevance, and the location.

One or more of the following features may be included. The communication session may include one or more of instant messaging, email, social networking communication, voice communication, video communication, and an electronic meeting. The location associated with the application activity may include a location of the first participant during the application activity. The location associated with the application activity may include a location of content associated with the application activity.

The processor configured for storing the association between the communication session, the application activity, the relevance, and the location may be further configured for storing a sequenced description of the application activity. The processor may also be configured for generating a sequential recall of the application activity for the communication session.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes an activity recall process according to an implementation of the present disclosure;

FIG. 2 is a flowchart of the activity recall process of FIG. 1, according to an implementation of the present disclosure;

FIG. 3 diagrammatically depicts an implementation of the activity recall process according to an example embodiment of the present disclosure;

FIG. 4 is a diagrammatic view of the computing device of FIG. 1, according to an implementation of the present disclosure.

Like reference symbols in the various drawings indicate like elements.

### DETAILED DESCRIPTION

Users may communicate with one another using a wide array of communication applications, tools, and formats. For example, users may engage in synchronous, and/or real-time, communications, such as instant messaging, voice—or video—conferencing, electronic meetings (e.g., emeetings, web-conferences, etc.), and the like. Similarly, users may participate in communications that may be either synchronous, or asynchronous, such as exchanged emails, posted content to social networking sites, shared collaborative spaces, or other forums, in which other users may post replies or follow-up messages in real-time, or near real-time, or at some later point in time. Such various types of communications tools may facilitate collaboration between users for either, or both, personal and professional activities.

Often while people are engaged in communications sessions with other, the participants of the communication sessions may be performing multiple other tasks. Some of the tasks being performed by the participants may be related to the communication session, while other activities may be unrelated to the communication session. It may be difficult to recall what activities where being performed during the course of a given communication session, particularly, for example, days or weeks afterwards. Consistent with an embodiment, the present disclosure may enable activities that are being performed by a participant during the general timeframe of a communication session to be logged, and later recalled. For example, the type of activity being performed (e.g., accessing content using a web browser or preparing a document using a word processing application), the content involved (e.g., web content, source code being edited, media content being watched or listened to), and/or the location of the participant while performing the activity or of the content upon which the activity is performed, may be logged for later recall. In some embodiments, a relevance level between the activity being performed (and/or the content upon which the activity is being performed) and the communication session may be determined or inferred and may be logged as well. The logged, or stored, activity may be recalled at a later time, which may provide the participant of the communication session with information or insight into what activities he or she was performing, or content that he or she was interacting with, during the general time frame of the communication session.

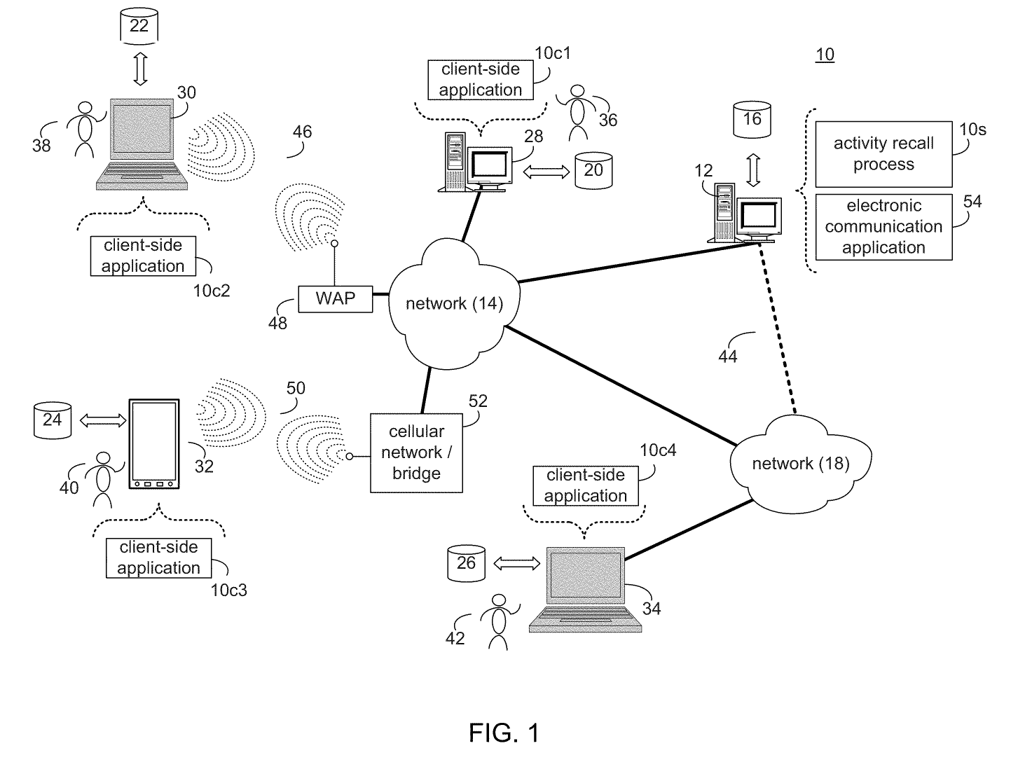

Referring to FIG. 1, there is shown activity recall process 10. For the following discussion, it is intended to be understood that activity recall process 10 may be implemented in a variety of ways. For example, activity recall process 10 may be implemented as a server-side process, a client-side process, or a server-side/client-side process.

For example, activity recall process 10 may be implemented as a purely server-side process via activity recall process 10s. Alternatively, activity recall process 10 may be implemented as a purely client-side process via one or more of client-side application 10c1, client-side application 10c2, client-side application 10c3, and client-side application 10c4. Alternatively still, activity recall process 10 may be implemented as a server-side/client-side process via server-side activity recall process 10s in combination with one or more of client-side application 10c1, client-side application 10c2, client-side application 10c3, and client-side application 10c4. In such an example, at least a portion of the functionality of activity recall process 10 may be performed by activity recall process 10s and at least a portion of the functionality of activity recall process 10 may be performed by one or more of client-side application 10c1, 10c2, 10c3, and 10c4.

Accordingly, activity recall process 10 as used in this disclosure may include any combination of activity recall process 10s, client-side application 10c1, client-side application 10c2, client-side application 10c3, and client-side application 10c4.

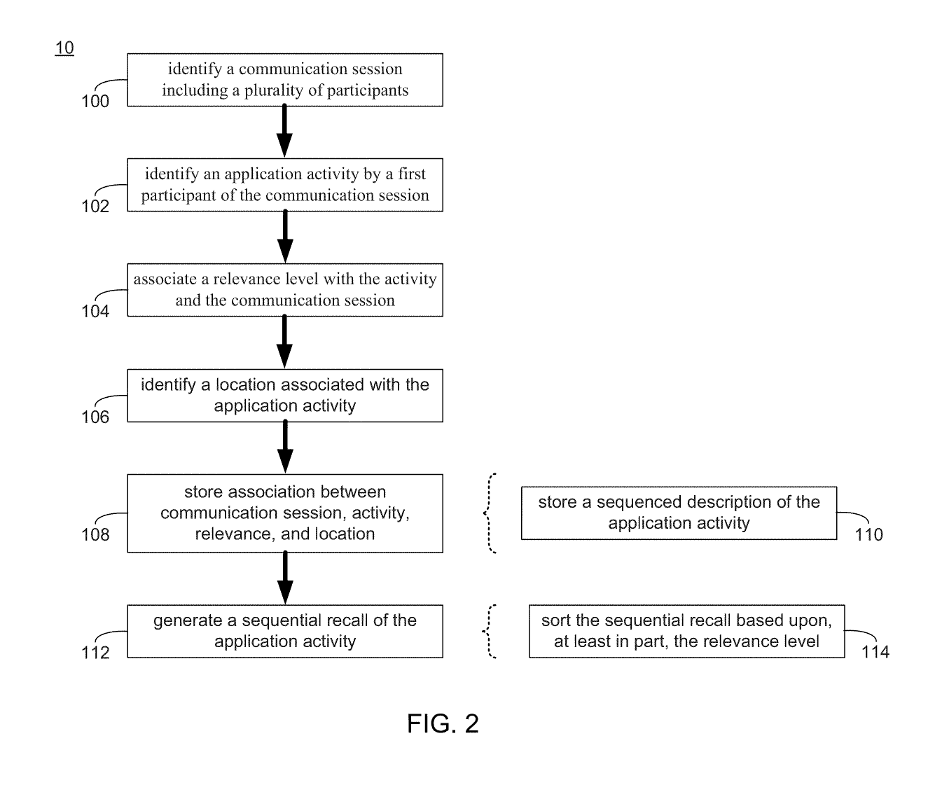

Referring also to FIG. 2, and as will be discussed in greater detail below, activity recall process 10 may identify 100 a communication session including a plurality of participants. Activity recall process 10 may also identify 102 an application activity by a first participant of the communication session. The application activity may be generally contemporaneous with the communication session. Activity recall process 10 may also associate 104 a relevance level with the application activity and the communication session. Activity recall process 10 may also identify 106 a location associated with the application activity. Activity recall process 10 may further store 108 an association between the communication session, the application activity, the relevance, and the location.

Activity recall process 10s may be a server application and may reside on and may be executed by computing device 12, which may be connected to network 14 (e.g., the Internet or a local area network). Examples of computing device 12 may include, but are not limited to: a personal computer, a server computer, a series of server computers, a mini computer, a mainframe computer, or a dedicated network device.

The instruction sets and subroutines of activity recall process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a tape drive; an optical drive; a RAID device; an NAS device, a Storage Area Network, a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of client-side applications 10c1, 10c2, 10c3, 10c4 may include but are not limited to, one or more of a media consumption application, a media transport application, a video playback application, a web browser, or a specialized application (e.g., an application running on a mobile platform). The instruction sets and subroutines of client-side application 10c1, 10c2, 10c3, 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Examples of storage devices 20, 22, 24, 26 may include but are not limited to: hard disk drives; tape drives; optical drives; RAID devices; random access memories (RAM); read-only memories (ROM), and all forms of flash memory storage devices.

Examples of client electronic devices 28, 30, 32, 34 may include, but are not limited to, personal computer 28, laptop computer 30, a mobile computing device 32 (such as a smartphone, a table computer, etc.), notebook computer 34, a netbook computer (not shown), a server computer (not shown), a gaming console (not shown), a set-top box, a data-enabled television console (not shown), and a dedicated network device (not shown). Client electronic devices 28, 30, 32, 34 may each execute an operating system.

Users 36, 38, 40, 42 may access quality of service process 10 directly through network 14 or through secondary network 18. Further, quality of service process 10 may be accessed through secondary network 18 via link line 44.

The various client electronic devices (e.g., client electronic devices 28, 30, 32, 34) may be directly or indirectly coupled to network 14 (or network 18). For example, personal computer 28 is shown directly coupled to network 14. Further, laptop computer 30 is shown wirelessly coupled to network 14 via wireless communication channels 46 established between laptop computer 30 and wireless access point (WAP) 48. Similarly, mobile computing device 32 is shown wirelessly coupled to network 14 via wireless communication channel 50 established between mobile computing device 32 and cellular network/bridge 52, which is shown directly coupled to network 14. WAP 48 may be, for example, an IEEE 802.11a, 802.11b, 802.11g, 802.11n, Wi-Fi, and/or Bluetooth device that is capable of establishing wireless communication channel 46 between laptop computer 30 and WAP 48. Additionally, personal computer 34 is shown directly coupled to network 18 via a hardwired network connection.

In some embodiments, activity recall process 10 may communicate with, interact with, and/or include a component or module of a communication application (e.g., communication application 54). As is generally known, a communication application (e.g., communication application 54) may generally facilitate text, audio and/or video communications between individuals as participants in a communication session. For example, communication application 54 may facilitate instant messaging communications, email communications, voice over IP and/or video over IP communications, electronic meetings, communications via social networking or other collaborative applications or websites, and/or other communication sessions between participants. In some embodiments, a communication session may only include two participants. In some embodiments, a communication session may include more than two participants. In some embodiments, communication application 54 may include, and/or may interact with, for example, an instant messaging application, an email application, a social networking application, an electronic meeting application, a web conferencing application, a voice, or video, over IP application, or a similar application. An example of communication application 54 may include, but is not limited to, Lotus® Sametime®. (Lotus and Sametime are registered trademarks of International Business Machine Corporation in the United States, other countries, or both).

In an embodiment, the instruction sets and subroutines of electronic communication application 54 may be stored, e.g., on storage device 16 associated with server computer 12, which executes electronic communication application 54, and/or another suitable storage device. Further, users (e.g., one or more of users 36, 38, 40, 42) may access electronic communication application 54 in order to participate in an electronic communication session (such as an instant messaging chat, an email exchange, a voice call, a video call, an electronic meeting, or other communication session type). The users may access electronic communication application 54 via one or more suitable applications, such as client side applications 10c1-10c4 (e.g., which may include an instant messaging application, an email application, a voice-over-IP application, a video-over-IP application, a web browser, a client electronic meeting application, or another application) and/or via a different application (not shown). As generally discussed above, a portion and/or all of the functionality of quality of service process 10 may be provided by one or more of client side applications 10c1-10c4. For example, in some embodiments quality of service process 10 (and/or client-side functionality of quality of service process 10) may be included within and/or interactive with client-side applications 10c1-10c4, which may include client side electronic communication applications, web browsers, or another application. Various additional/alternative configurations may be equally utilized.

As generally discussed above with reference to FIG. 2, activity recall process 10 may identify 100 a communication session including a plurality of participants. Activity recall process 10 may also identify 102 an application activity by a first participant of the communication session. The application activity may be generally contemporaneous with the communication session. Activity recall process 10 may also associate 104 a relevance level with the application activity and the communication session. Activity recall process 10 may also identify 106 a location associated with the application activity. Activity recall process 10 may further store 108 an association between the communication session, the application activity, the relevance, and the location.

As generally described above, activity recall process 10 may identify 100 a communication session including a plurality of participants. For example a user (such as user 36) may engage in an online communication with one or more other users, who may all be participants in the communication session. Activity recall process 10 may identity that the communication session has been initiated (for example based upon, at least in part, receiving an indication from a relevant communication application. Activity recall process 10 may identify the type of communication session (e.g., the communication application and/or format of the communication session) that is occurring between the participants. The communication session may include one or more of instant messaging, email, social networking communication, voice communication, video communication, and an electronic meeting. As part of identifying 100 the communication session, activity process 10 may identify the participants of the communication session. For example, as mentioned above, the communication session may be between user 36 and one or more other individuals, who may be all be participants in the communication session. Activity recall process 10 may also determine various other attributes regarding the communication session, for example, the time at which the communication session occurred, who the initiating participant was, times at which other participants joined and left the communication session, the duration of the communication session which portions of the communication session were contributed by which participant, as well as various additional and/or alternative attributes.

Activity recall process 10 may also identify 102 an application activity by a first participant of the communication session. The application activity may be generally contemporaneous with the communication session. For example, as may often be the case, one or more participants of the communication session may engage in different activities while the communication session is ongoing. Activity recall process 10 may identify what applications a participant of the communication session interacts with during the course of the communication session, and may identify what actions or activities the participant performs via the applications.

For example, during the course of an instant messaging communication session user 36 may interact with a web browser, such as by clicking on a link that was included in a message from another participant of instant messaging communication session. Further, user 36 may open a browser window and access one or more web pages during the course of the instant messaging communication session. User 36 may also open a presentation and copy content from a presentation slide and paste it into a message that is part of the instant messaging communication session. Further, user 36 may access a document editing application, and during the course of the instant messaging communication session, may type in the document, and switch back and forth between the instant messaging application (e.g., via which user 36 may participate in the instant messaging communication session) and the document editing application several times, occasionally typing in the document. Further, user 36 may resize and/or reposition one or more of the instant messaging application and an email application such that each application may be simultaneously viewable. From the resized and/or repositioned email application, user 36 may access one or more emails.

Activity recall process 10 may identify 102 the various application activities of user 36 during the course of the instant messaging communication session. For example, activity recall process 10 may identify 102 that user 36 opened a browser link (e.g., which may include capturing the link that was opened, the time at which the link was opened, etc.) from a received instant message of the instant messaging communication session. Activity recall process 10 may further identify 102 that user 36 accessed web content using a browser (e.g., which may include identifying the time that the content was accessed, and the URL of the content that was accessed). Activity recall process 10 may also identify 102 that user 36 copied content from a presentation slide (e.g., which may include identifying the location of the presentation file and the content that was copied from which presentation slide, and the time of the activity), and pasted the content into an instant message of the instant messaging communication session. Activity recall process 10 also identify 102 that user 36 accessed a document and typed content in the document (e.g., which may include identifying the file location of the document that was accessed, and the content that was typed, as well as the times at which the document was edited by user 36). Further, activity recall process 10 may identify 102 that user 36 resized and/or repositioned a user interface of an email application to be viewable simultaneously with the instant messaging user interface (e.g., which may include identifying the email messages that were accessed during the instant messaging communication session, and when the individual email messages were accessed by user 36). Various additional and/or alternative application activities by user 36 may similarly be identified. Accordingly, activity recall process 10 may identify activities performed by user 36 (as a participant of the communication session), the applications via which the activities were performed, when the activities occurred, and any content that may be created, modified, and/or accessed through the activity.

Activity recall process 10 may also associate 104 a relevance level with the application activity and the communication session. For example, while a participant of a communication session may engage in various activities during the course of the communication session, various ones of the activities may be more, or less, relevant to the communication session. Additionally/alternatively, various ones of the activities and/or may be more, or less, relevant from a perspective of memorializing the activity. For example, and referring to the above illustrative description, accessing the presentation and copying content from one of the presentation slides into an instant message of the instant messaging communication session may be highly relevant to the instant messaging communication session (e.g., providing an indication of where the content pasted into the instant message came from—the presentation slide, and how the content came to be part of an instant message—by being copy-and-pasted from a presentation slide). As such, activity recall process 10 may associate 104 a relatively high relevance level with accessing the presentation slide and copying the content from the presentation slide into an instant message. Activity recall process 10 may also associate 104 a relatively high relevance with opening (e.g., via a web browser) the link that was included in an instant message of the instant messaging communication session, for example as the activity (opening the link) may have arisen as a result of the communication session (e.g., as user 36 received the link via an instant message of the instant messaging communication session). Activity recall process 10 may associate 104 a moderate relevance level with each of the illustrative activities of accessing web content and editing a document. For example, the web content and the document may be related to the instant messaging communication session, or they may not be related to the instant messaging communication session. Further, activity recall process 10 may associate 104 a relatively low relevance level with the resizing and/or repositioning of the email user interface and the instant messaging user interface.

Activity recall process 10 may associate 104 a relevance level with the application activity in real time (e.g., as the activity is being performed) and/or after the activity has been performed and/or after the communication session has concluded. In the foregoing description, various rationale for associating relative relevance levels with different activities has been discussed. Such rationale has been provided only for illustrative purposes. Various additional, or alternative, rationale may be utilized for associating relevance levels with activities. Accordingly, different rationale may result in different relevance levels being associated with the above illustrative activities than has been described herein. In some implementations, the relevance level may, for example, be based upon, at least in part, a relevance, or likely relevance, of the activity with respect to the communication session. For example, an activity that is more closely tied to the communication session may have a relatively higher associated relevance level.

Activity recall process 10 may also identify 106 a location associated with the application activity. In an embodiment, the location associated with the application activity may include a location of the first participant during the application activity. For example, in addition to identifying a 102 the activity, activity recall process 10 may also identify a location associated with the first participant at the time of the activity. Continuing with the above-example, the location of user 36 may be identified 106 based upon, at least in part, an IP address associated with personal computer 28. Various additional and/or alternative location attributes may similarly be identified 106, such as the location of personal computer 28 within a network, a location of personal computer 28 based upon, for example, a user input, or based upon, at least in part, other location-based attributes. Further, some computing devices may support location-based services that may be utilized to identify 106 a location of the computing device, and thereby the user of the computing device, at the time of the activity. For example, a mobile computing device (such as a smartphone, a tablet computer, a notebook computer, or the like) may include GPS functionality, may access a cellular network via one or more cell towers (e.g., which may enable identifying a general location, or a specific location, e.g., via triangulation or the like), or may access a wireless network (such as a WiFi network) that may allow the location of the computing device to be identified 106 (e.g., with varying degrees of accuracy and precision).

Additionally and/or alternatively, the location associated with the application activity may include a location of content associated with the application activity. That is, the location of one or more pieces of content created, modified, or accessed via an application utilized by a participant during the course of the communication session may be identified. The location of the content may include, for example, a URL, a network directory location, a file location on a particular computing device or within a datastore, etc. For example, in the illustrative scenario described above, user 36 may click a link that may be opened via a web browser. The link, which may identify the location of the content, may be identified 108 as a location of the content. Similarly, user 36 may access various websites during the course of the instant messaging communication session. The URL's of the webpages accessed by user 36 may be identified 106 as locations of content. The presentation, the particular slide, and the content copied from the particular slide may all be identified 106, for example, including a location of the presentation (which may be stored in a shared collaborative workspace, on a storage device local to personal computer 28, etc.). Similarly, the document that is accessed and edited by user 36 may be identified (e.g., as a location on the storage device local to personal computer 28, a document repository, a shared collaborative workspace, etc.). Further, the location of the emails accessed during the instant messaging communication session may be identified 106 (e.g., based upon, at least in part, a mailbox and/or folder within a mailbox, of a particular email account, etc.).

Activity recall process 10 may further store 108 an association between the communication session, the application activity, the relevance, and the location. For example, activity recall process 10 may log the activity, the content associated with the activity, the associated relevance level, and the location, and may store the information associated with the communication session. According to such an embodiment, activity recall process 10 may map the activities performed by the participant in the communication session with the communication session itself, with a relevance level associated with the communication session, and with a location (e.g., a location of the participant and/or of the content created, modified, or accessed during the performance of the activity). In an embodiment, activity recall process 10 may store 108 the association between the communication session, the application activity, the relevance, and the location as part of and/or along with a transcript of the communication session, which may stored locally relative to the computing device associated with the first participant (e.g., user 36 in the above illustrative example) and/or may be stored in connection with server computer 12, which may execute communication application 54 (e.g., on storage device 16 and/or a datastore accessible by communication application 54).

Storing 108 the association between the communication session, the application activity, the relevance, and the location may include storing 110 a sequenced description of the application activity. For example, activity recall process may store 110 a description of the various activities performed by the first participant of the communication session in the sequence, or order, in which the first participant performed the activities during the communication session. Continuing with the foregoing illustrative example, storing 110 the sequenced description of application activity may include storing a log indicating that user 36 1) opened the link included within an instant message from a second participant in the communication session; 2) accessed website A; 3) accessed website B; 4) copy and pasted content from slide four of “Marketing Excellence” presentation; 5) switched from IM to document “Workflow Update” five times within seven minutes; 6) resized window allowing viewing of both IM client and email client. It will be appreciated that the sequenced description stored 110 by activity recall process 10 may include greater or lesser degrees of specificity.

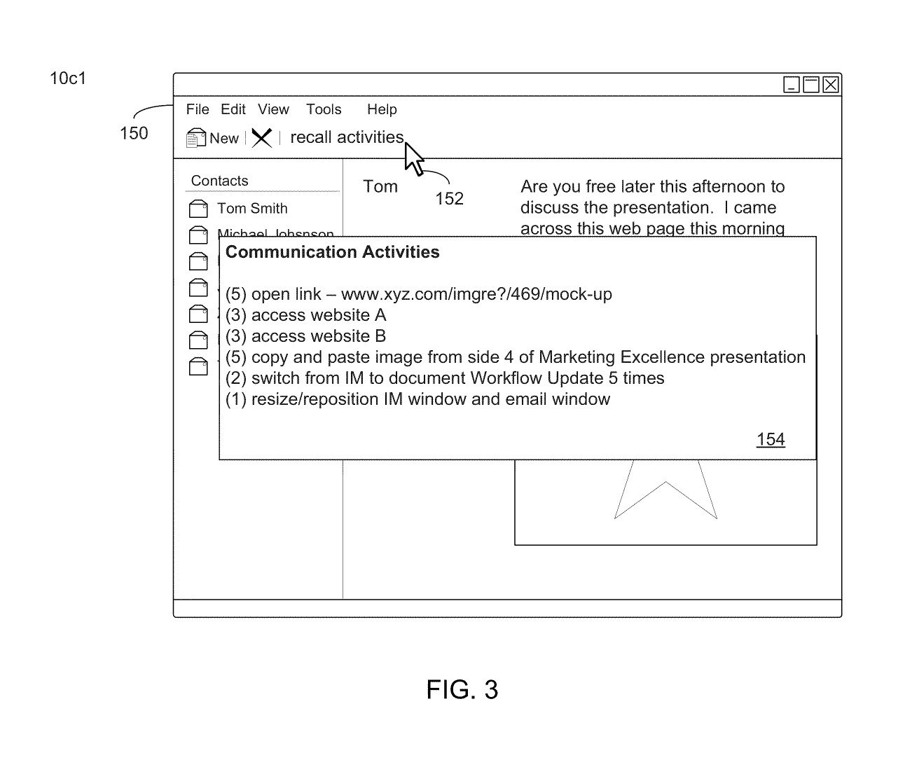

Activity recall process 10 may also generate 112 a sequential recall of the application activity for the communication session. For example, to enable a user to review activities that were performed during the course of a communication session. Referring also to FIG. 3, in an illustrative example, a participant of a communication session (e.g., user 36) may access a sequential recall of application activities that were performed during a communication session. For example, user 36 may access an instant messaging communication session transcript via chat transcript display 150 (e.g., which may be provided, at least in part, by a client application, such as client application 10c1, which may provide and/or allow access to at least a portion of the functionality of activity recall process 10). In the illustrated example, from within chat transcript display 150 user 36 may select, e.g. using onscreen pointer 152 (or another input selection feature, such as a touch screen interface, etc.), a “recall activities” option. In response to selecting the “recall activities” option, activity recall process 10 may generate 112 communication activities display 154, which may include a sequential listing of the activities that were performed by user 36 during the course of the instant messaging communication session associated with the displayed chat transcript. While not shown in FIG. 3, additional information regarding the activities performed may be included within communications activities display 154. Examples of such additional information may include, for example, a time at which each activity was performed, and identification of the application through which the activity was performed, a location and/or hyperlink to any files or resources that were involved in the activity, etc. It will be appreciated that other mechanisms may be implemented for accessing a generated sequential recall of the application activities for the communication session.

Generating 112 the sequential recall may include sorting 114 the sequential recall based upon, at least in part, the relevance level. Sorting 114 the sequential recall based upon, at least in part, the relevance level may include, for example, associating a relevance level indicator with each activity included within the generated 112 sequential recall. For example, as shown in FIG. 3, each item included within communication activities display 154 may include an associated numerical indicator of the relevance level of the activity (e.g., on a scale from 1 to 5, with 5 being the highest relevance level, in the depicted example). Other indicators of relevance level may equally be utilized. Further, in some embodiments, the listing of activities performed during the communication session may be arranged in an order of descending and/or ascending relevance level. In such an embodiment, for example, an indicator (such as a time stamp or the like) may be utilized to indicate a sequence, or time-wise order, in which the various activities were performed during the course of the communication session.

In some implementations, the activity recall process may monitor and log activities that a user performs during a communication session. The activity recall process may also identify and log locations of files implicated in the activity and/or a location of the user performing the activity. Additionally, the activity recall process may allow a user the “play back” the activities that were performed during the communication session, for example by providing a sequenced listing of the activities performed, which may include an indication of the order in which the various activities were performed. Further, in some implementations the activity recall process may also provide an indicator of how relevant each activity may be to the communication session.

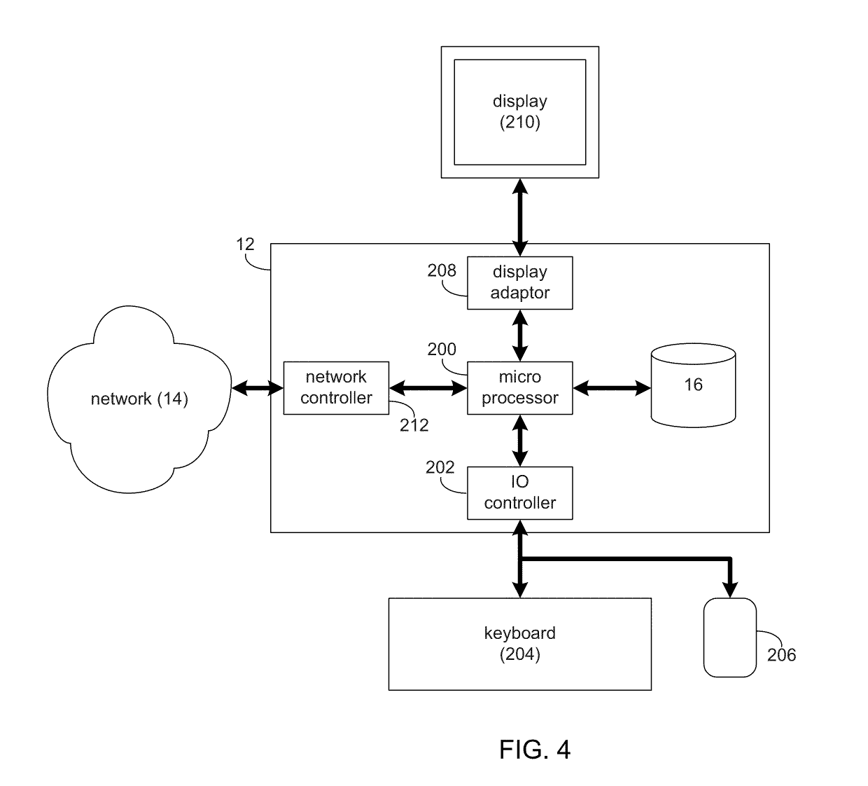

Referring also to FIG. 4, there is shown a diagrammatic view of computing system 12. While computing system 12 is shown in this figure, this is for illustrative purposes only and is not intended to be a limitation of this disclosure, as other configuration are possible. For example, any computing device capable of executing, in whole or in part, activity recall process 10 may be substituted for computing device 12 within FIG. 4, examples of which may include but are not limited to client electronic devices 28, 30, 32, 34.

Computing system 12 may include microprocessor 200 configured to e.g., process data and execute instructions/code for activity recall process 10. Microprocessor 200 may be coupled to storage device 16. As discussed above, examples of storage device 16 may include but are not limited to: a hard disk drive; a tape drive; an optical drive; a RAID device; an NAS device, a Storage Area Network, a random access memory (RAM); a read-only memory (ROM); and all forms of flash memory storage devices. IO controller 202 may be configured to couple microprocessor 200 with various devices, such as keyboard 204, mouse 206, USB ports (not shown), and printer ports (not shown). Display adaptor 208 may be configured to couple display 210 (e.g., a CRT or LCD monitor) with microprocessor 200, while network adapter 212 (e.g., an Ethernet adapter) may be configured to couple microprocessor 200 to network 14 (e.g., the Internet or a local area network).

As will be appreciated by one skilled in the art, the present disclosure may be embodied as a method (e.g., executing in whole or in part on computing device 12), a system (e.g., computing device 12), or a computer program product (e.g., encoded within storage device 16). Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium (e.g., storage device 16) having computer-usable program code embodied in the medium.

Any suitable computer usable or computer readable medium (e.g., storage device 16) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, C#.NET, PHP, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor (e.g., processor 200) of a general purpose computer/special purpose computer/other programmable data processing apparatus (e.g., computing device 12), such that the instructions, which execute via the processor (e.g., processor 200) of the computer or other programmable data processing apparatus, create means for implementing the functions/acts specified in the flowchart and/or block diagram block or blocks.

These computer program instructions may also be stored in a computer-readable memory (e.g., storage device 16) that may direct a computer (e.g., computing device 12) or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer (e.g., computing device 12) or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

Having thus described the disclosure of the present application in detail and by reference to embodiments thereof, it will be apparent that modifications and variations are possible without departing from the scope of the disclosure defined in the appended claims.

What is claimed is:

1. A computer-implemented method comprising:
identifying, by a computing device, a communication session including a plurality of participants;
identifying an application activity by a first participant of the communication session, the application activity being generally contemporaneous with the communication session;
associating a relevance level with the application activity and the communication session;
identifying a location associated with the application activity; and
storing an association between the communication session, the application activity, the relevance, and the location.

2. The computer-implemented method of claim 1, wherein the communication session includes one or more of instant messaging, email, social networking communication, voice communication, video communication, and an electronic meeting.

3. The computer-implemented method of claim 1, wherein the location associated with the application activity includes a location of the first participant during the application activity.

4. The computer-implemented method of claim 1, wherein the location associated with the application activity includes a location of content associated with the application activity.

5. The computer-implemented method of claim 1, wherein storing the association between the communication session, the application activity, the relevance, and the location includes storing a sequenced description of the application activity.

6. The computer-implemented method of claim 1, further comprising generating a sequential recall of the application activity for the communication session.

7. The computer-implemented method of claim 6, further including sorting the sequential recall based upon, at least in part, the relevance level.

8. A computer program product comprising a computer readable storage medium having a plurality of instructions stored thereon, which, when executed by a processor, cause the processor to perform operations including:
identifying a communication session including a plurality of participants;
identifying an application activity by a first participant of the communication session, the application activity being generally contemporaneous with the communication session;
associating a relevance level with the application activity and the communication session;
identifying a location associated with the application activity; and
storing an association between the communication session, the application activity, the relevance, and the location.

9. The computer program product of claim 8, wherein the communication session includes one or more of instant messaging, email, social networking communication, voice communication, video communication, and an electronic meeting.

10. The computer program product of claim 8, wherein the location associated with the application activity includes a location of the first participant during the application activity.

11. The computer program product of claim 8, wherein the location associated with the application activity includes a location of content associated with the application activity.

12. The computer program product of claim 8, wherein the instructions for storing the association between the communication session, the application activity, the relevance, and the location include instructions for a storing a sequenced description of the application activity.

13. The computer program product of claim 8, further comprising instructions for generating a sequential recall of the application activity for the communication session.

14. The computer program product of claim 13, further including instructions for sorting the sequential recall based upon, at least in part, the relevance level.

15. A computing system comprising:
a processor and a memory architecture coupled with the processor, the processor configured for:
identifying a communication session including a plurality of participants;
identifying an application activity by a first participant of the communication session, the application activity being generally contemporaneous with the communication session;
associating a relevance level with the application activity and the communication session;
identifying a location associated with the application activity; and
storing an association between the communication session, the application activity, the relevance, and the location.

16. The computing system of claim 15, wherein the communication session includes one or more of instant messaging, email, social networking communication, voice communication, video communication, and an electronic meeting.

17. The computing system of claim 15, wherein the location associated with the application activity includes a location of the first participant during the application activity.

18. The computing system of claim 15, wherein the location associated with the application activity includes a location of content associated with the application activity.

19. The computing system of claim 15, wherein the processor configured for storing the association between the communication session, the application activity, the relevance, and the location is further configured for storing a sequenced description of the application activity.

20. The computing system of claim 1, the processor being further configured for generating a sequential recall of the application activity for the communication session.
